(19) United States
(12) Patent Application Publication
(10) Pub. No.: US 2019/0264831 A1
(43) Pub. Date: Aug. 29, 2019

(54) VALVE MONITOR SYSTEM

(71) Applicant: Saudi Arabian Oil Company, Dhahran (SE)

(72) Inventors: Mohammed Abdulaziz Altirbaq, Riyadh (SA); Mohammed Yahya Hakami, Riyadh (SA)

(21) Appl. No.: 15/906,429

(22) Filed: Feb. 27, 2018

(51) Int. Cl. F16K 37/00

(52) U.S. Cl. CPC F16K 37/0008; F16K 37/0041

(57) ABSTRACT

The invention pertains to a valve monitor system comprising a valve operation mode selector indicator that provides a local indicator to maintenance personnel of whether a valve operation mode selector switch is placed in a local or remote position. The valve monitor system also provides a circuit to a central control room or facility, to allow an operator there to know whether a pipeline valve controlled by the valve operation mode selector switch is configured for local or remote operation.

### FIELD OF THE INVENTION

The invention pertains to a valve monitor system comprising a valve operation mode selector indicator that provides an indicator to local maintenance personnel of whether a valve operation mode selector switch is placed in a local or remote position. The valve monitor system also provides a circuit to a central control room or facility, to allow an operator there to know whether a pipeline valve controlled by the valve operation mode selector switch is configured for local or remote operation.

### BACKGROUND OF THE INVENTION

Gas-operated pipeline valves are frequently provided with a valve operation mode selector switch mounted on a selector valve, allowing the pipeline valve to be configured either for local or remote operation. If the selector switch is in the local mode, then the pipeline valve can only be controlled locally. If the selector switch is in the remote mode, then the pipeline valve can only be operated remotely, for example from a central control room or facility.

When performing inspection and maintenance of a gas-operated pipeline valve or related system, maintenance personnel may want to ensure that the gas-operated pipeline valve is in the local mode, to reduce the risk of a remote operator operating the valve while the maintenance personnel are working on it, which could increase the risk of damage or injury. In such a situation, the maintenance personnel adjust the mode selector switch from the remote mode of operation to the local mode of operation, to prevent a remote operator from opening the gas-operated pipeline valve.

Sometimes, upon completion of the inspection and maintenance of the pipeline valve, the maintenance personnel may forget to reset the mode selector switch for remote operation of the pipeline valve, and may then leave the vicinity. In such a case, a remote operator may have no indication if the pipeline valve is configured for local or remote operation, and may incorrectly believe that control of the gas-operated valve has been restored to him.

What is needed is a system including a valve mode selector indicator that provides local maintenance personnel with a visible indicator of whether the selector switch is positioned for local or remote operation of the pipeline valve, and that also provides a remote indication to an operator in the central control room or facility of whether the mode selector switch is positioned for local or remote operation of the pipeline valve.

### SUMMARY OF THE INVENTION

The invention pertains to a valve monitor system comprising a valve operation mode selector indicator that provides an indicator to local maintenance personnel of whether a valve operation mode selector switch is placed in a local or remote position. The valve monitor system also provides a circuit to a central control room or facility, to allow an operator there to know whether a pipeline valve controlled by the valve operation mode selector switch is configured for local or remote operation.

### BRIEF DESCRIPTION OF THE DRAWINGS

Preferred embodiments of the invention are described herein below with reference to the drawings wherein:

FIG. 1 illustrates a front elevation of an inner element of the mode selector indicator;

FIG. 2 illustrates a side view of the inner element;

FIG. 3 illustrates a front elevation of an outer element of the mode selector indicator;

FIG. 4 illustrates a side view of the outer element;

FIG. 5 illustrates a front view of the inner and outer elements of the mode selector indicator mounted on a selector valve and in the remote position;

FIG. 6 illustrates a front view of the inner and outer rings of the mode selector indicator mounted on a selector valve and in the local position;

FIG. 7 illustrates a control circuit providing indication to a central control room that the selector switch is in the remote position; and

FIG. 8 illustrates a control circuit providing indication to a central control room that the selector switch is in the local position.

### DETAILED DESCRIPTION OF THE INVENTION

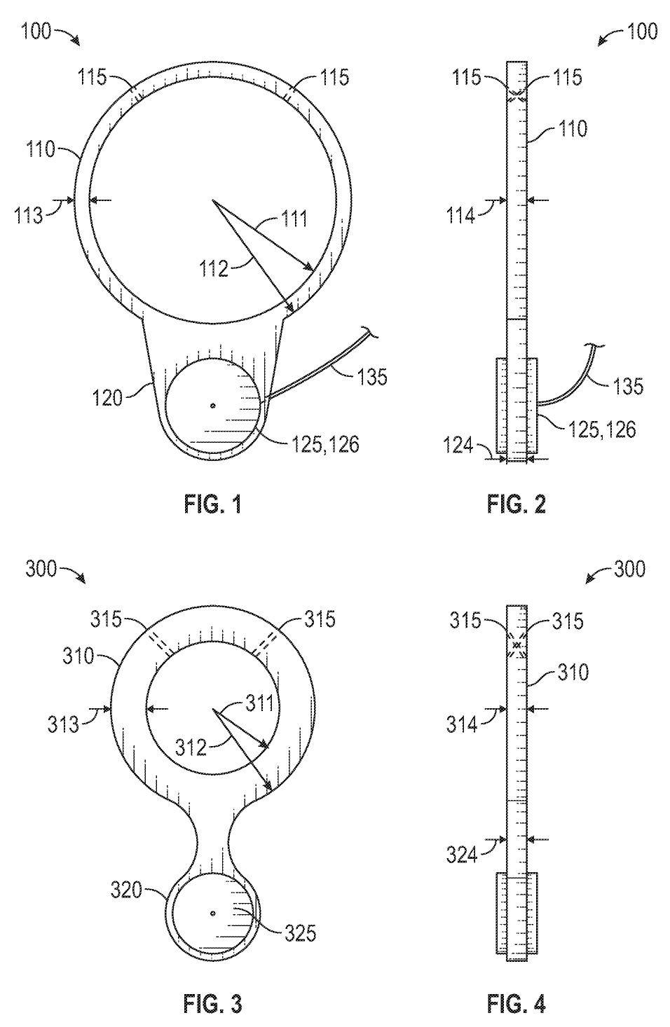

The valve monitor comprises a pair of elements, each comprising mounting rings and having extensions that serve as visual indicators. FIGS. 1 and 2 illustrate an inner element 100 of the valve monitor, comprising an inner mounting ring 110 with inner diameter 111 and outer diameter 112, therefore having a width 113 between the inner diameter 111 and outer diameter 113. Inner mounting ring 110 has a thickness 114.

Inner element 100 is designed to be mounted in a fixed position on a selector valve, such as to the valve body or the valve bonnet. In a preferred embodiment, at least one mounting hole 115 is provided through inner mounting ring 110 to allow for mounting to the selector valve, such as a threaded hole 115 accepting a set screw to secure the inner element 100 to a valve bonnet having an outer diameter slightly smaller than the inner diameter 111 of inner mounting ring 100. One of ordinary skill in the art will understand that other mounting arrangements are possible.

Inner element 100 is provided with an extension 120 that provides a circular insert 125. Circular insert 125 includes a magnetic proximity switch 126 that is responsive to a ferrous item. In a preferred embodiment, extension 120 has a thickness 124 that is less than thickness 114 of inner mounting ring 100.

Extension 120 is made of a non-ferrous metal. In a preferred embodiment, inner mounting ring 110 is also made of a non-ferrous metal. In another preferred embodiment, inner element 100 is made from a single piece of metal. In another preferred embodiment, inner element 100 is made from austenitic stainless steel.

Extension 120 provides enough distance from the valve body or valve bonnet to which inner element 100 is mounted, so that the proximity switch 126 is not activated by a ferrous valve body. Similarly, for an embodiment in which mounting ring 110 is made of a ferrous metal, the non-ferrous extension 120 will provide enough distance so that proximity switch 126 is not activated by the ferrous metal of mounting ring 110.

A cable 135 is wired from the proximity switch 126 to a control system, such as a remote terminal unit (RTU), as will be discussed later.

FIGS. 3 and 4 illustrate an outer element 300 of the valve monitor, comprising an outer mounting ring 310 with inner diameter 311 and outer diameter 312, therefore having a width 313 between the inner diameter 311 and outer diameter 313. Outer mounting ring 310 has a thickness 314.

Outer element 300 is designed to be mounted on the stem of the valve being monitored, so that outer element 300 will rotate with the rotation of the valve stem. In a preferred embodiment, at least one mounting hole 315 is provided through outer mounting ring 310 to allow for mounting to the valve stem, such as a threaded hole 315 accepting a set screw to secure the outer element 300 to a stem having an outer diameter slightly smaller than the inner diameter 311 of outer mounting ring 300. One of ordinary skill in the art will understand that other mounting arrangements are possible.

Outer element 300 is provided with an extension 320 that provides a circular insert 325. Circular insert 325 includes a piece of ferrous metal. In a preferred embodiment, extension 320 has a thickness 324 that is less than thickness 314 of outer mounting ring 300.

Extension 320 is made of a non-ferrous metal. In a preferred embodiment, outer mounting ring 310 is also made of a non-ferrous metal. In another preferred embodiment, outer element 300 is made from a single piece of metal. In another preferred embodiment, outer element 300 is made from austenitic stainless steel.

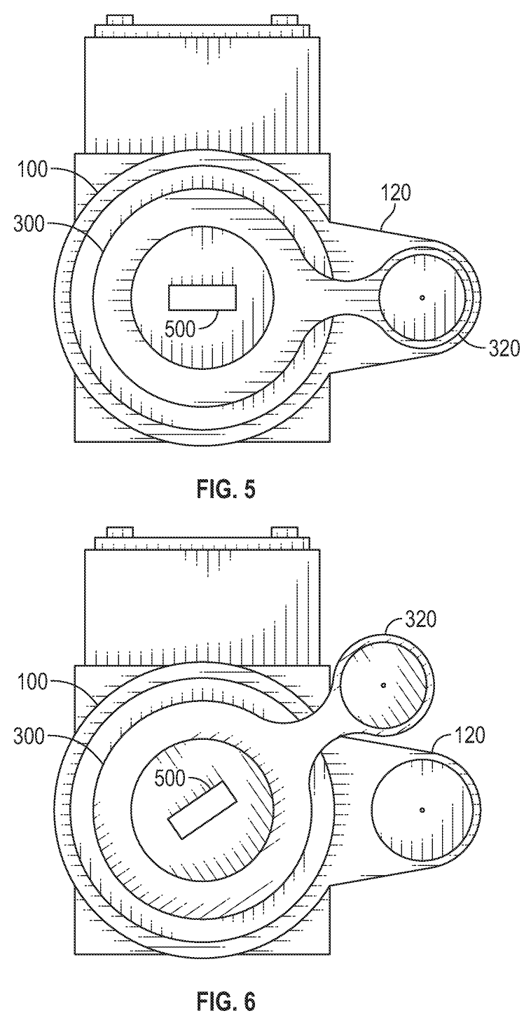

FIGS. 5-8 illustrate an installation of the valve monitor, in which inner element 100 is mounted to a valve bonnet, and outer element 300 is mounted to a valve stem. Handle 500 is also attached to the valve stem, allowing manual operation of the valve by maintenance personnel. In FIG. 5, handle 500 is turned so that the valve is positioned for remote operation, allowing a remote operator to automatically control the gas-operated pipeline valve. In this position, extension 320 of outer element 300 is adjacent to extension 120 of inner element 100, so that the ferrous metal in circular insert 325 of outer element 300 is adjacent to the magnetic proximity switch 126 of inner element 100. This closes the proximity switch 126, and cable 135 allows a control system to recognize that the valve is positioned for remote operation.

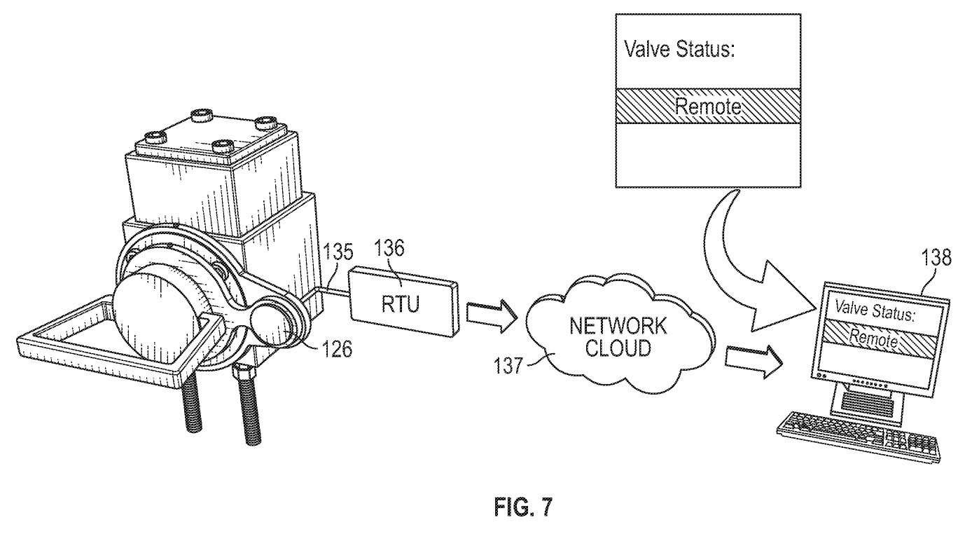

In FIG. 7, the control circuit comprises the cable 135 from proximity switch 126 to a remote terminal unit 136, and then via a network 137 to a terminal 138 within the central control room, informing the remote operator that the valve is positioned for remote operation.

In addition, circular inserts 125 and 325 are provided with visual indicators, such as yellow paint, to more readily allow local maintenance personnel to visually recognize that the pair of elements 100, 300 are aligned such that the valve is positioned for remote operation.

In FIG. 6, handle 500 is turned so that the valve is positioned for local operation, so that a remote operator cannot automatically control the gas-operated valve. In this position, extension 320 of outer element 300 is not adjacent to extension 120 of inner element 100, so that the ferrous metal in circular insert 325 of outer element 300 is not adjacent to the magnetic proximity switch 136 of inner element 100. This opens the proximity switch 136, and cable 135 allows the control system to recognize that the valve is positioned for local operation.

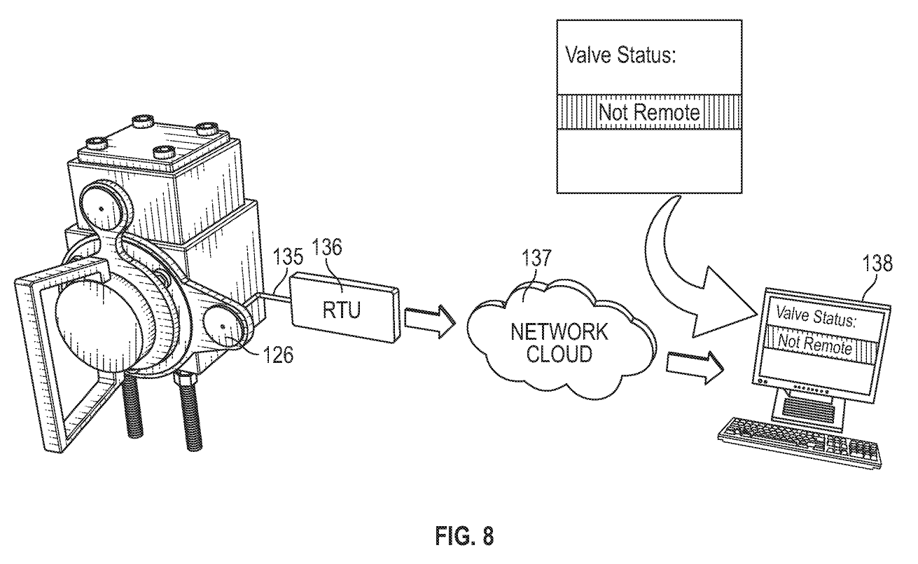

In FIG. 8, the control circuit comprises the cable 135 from proximity switch 126 to a remote terminal unit 136, and then via a network 137 to a terminal 138 within the central control room, informing the remote operator that the valve is positioned for local operation.

In this position, the visual indicators of circular inserts 125 and 325 allow local maintenance personnel to see that the pair of elements 100, 300 are aligned such that the valve is positioned only for local operation.

A number of advantages are recognized by the invention. The valve monitor can be used in a variety of extreme weather conditions, including areas with high temperature, areas that are very dusty or sandy, and areas with high humidity. The valve monitor can even be used while submerged. The magnetic proximity switch 136 allows for use in a hazardous area, as it does not generate any sparks.

While preferred embodiments of the present invention have been illustrated and described herein, it will be apparent that such embodiments are provided by way of example only. Numerous variations, changes and substitutions will be apparent to those skilled in the art without departing from the invention, the scope of which is to be determined by the following claims.

We claim:

1. A valve monitor for determining the position of a manually-operated valve, the valve monitor comprising:
an inner element comprising an inner mounting ring and an inner extension, the inner extension including a inner circular insert, the inner mounting ring being configured to mount to a body or bonnet of the manually-operated valve, and
an outer element comprising an outer mounting ring and an outer extension, the outer extension including an outer circular insert, the outer mounting ring being configured to mount to a stem of the manually-operated valve,
wherein the inner extension and the outer extension are made of a non-ferrous metal, and wherein a magnetic proximity switch is mounted within the inner mounting ring, and wherein a piece of ferrous metal is mounted within the outer mounting ring.

2. The valve monitor of claim 1, wherein the inner mounting ring and the inner extension are made from a single piece of non-ferrous metal.

3. The valve monitor of claim 1, wherein the outer mounting ring and the outer extension are made from a single piece of non-ferrous metal.

4. The valve monitor of claim 1, wherein the inner mounting ring and the inner extension are made from a first single piece of non-ferrous metal, and wherein the outer mounting ring and the outer extension are made from a second single piece of non-ferrous metal.

5. The valve monitor of claim 1, wherein the non-ferrous metal is austenitic stainless steel.

6. The valve monitor of claim 2, wherein the non-ferrous metal is austenitic stainless steel.

7. The valve monitor of claim 3, wherein the non-ferrous metal is austenitic stainless steel.

8. The valve monitor of claim 4, wherein the non-ferrous metal is austenitic stainless steel.
